(19) United States
(12) Patent Application Publication
(10) Pub. No.: US 2008/0178502 A1
(43) Pub. Date: Jul. 31, 2008

(54) VEHICLE IDENTIFICATION DEVICE AND RELATED METHODS

(76) Inventor: Bart Stuchell, Alliance, OH (US)

Correspondence Address: BROUSE MCDOWELL LPA, 388 SOUTH MAIN STREET, SUITE 500, AKRON, OH, 44311, US

(21) Appl. No.: 12/022,414

(22) Filed: Jan. 30, 2008

Related U.S. Application Data
(60) Provisional application No. 60/898,254, filed on Jan. 31, 2007.

(51) Int. Cl. G09F 7/00; B29C 65/70; B29C 65/72

(52) U.S. Cl. 40/200; 264/271.1; 156/242

(57) ABSTRACT

The present invention generally relates to devices and methods for labeling vehicles with visual and radio frequency indicia. Some embodiments include a plate having visually communicative indicia disposed thereon, and include one or more radio frequency labels. Some embodiments also include one or more mounting structures for mounting the plate to a vehicle. Additionally, some embodiments can optionally include one or more cover members, which may optionally include decorative elements.

### RELATED APPLICATIONS

The present application claims priority to U.S. Provisional Patent Application No. 60/898,254 filed Jan. 31, 2007, now pending, which is hereby incorporated by reference in its entirety.

### BACKGROUND OF THE INVENTION

I. Field of the Invention

The present invention generally relates to devices and methods for labeling vehicles with visual and radio frequency indicia.

II. Description of the Related Art

Vehicle identification tags are known in the art. Traditional tags, such as license plates, comprise stamped metal plates having visually communicative indicia on a face. Such plates are generally painted to render the visual components thereof readable from a distance. One problem with such tags is that they are only visually readable. Therefore, such tags cannot be read if the line of sight is disrupted, for instance, in poor weather conditions or if the line of sight is purposely disrupted, e.g. by covering the plate with a highly reflective lens or coating. Furthermore, plates that can only be read visually present an obstacle to reading the plate with a machine. Visual images can be problematic for a machine to interpret and convert into useful data. Thus, the art lacks a means for non-visual machine readable vehicle identification.

### SUMMARY OF THE INVENTION

The present invention generally relates to a vehicle identification device, comprising: a plate having a first face and a second face spaced apart from the first face and defining a thickness, the first and second faces defining an approximately rectangular shape, wherein the plate comprises one or more organic polymer materials, and wherein the plate further comprises a radio frequency identification label; a visually communicative alphanumeric label disposed on the first face; and at least one mounting structure adapted to mount the plate to a vehicle, the mounting structure being disposed on or in the plate.

Other embodiments comprise a process for making a vehicle identification device, comprising the steps of: providing at least one polymer material; molding the at least one polymer material to form a rectangular plate structure; embedding one or more in-mold labels members in the polymer material; and incorporating one or more radio frequency identification tags in the polymer material.

Some embodiment comprise a device for labeling a vehicle, comprising: a means for conveying visually perceptible indicia; a means for broadcasting a radio frequency signal indicia; and a means for mounting the device onto a vehicle.

### BRIEF DESCRIPTION OF THE DRAWINGS

Embodiments of the present invention will become better understood with reference to the following detailed description and claims taken in conjunction with the accompanying drawings, in which like elements correspond to like symbols, and in which:

FIG. 1 is a perspective drawing of an embodiment comprising a license plate;

FIG. 2 is a cross sectional drawing of a cap having a female clip for mounting to a plate; and

FIG. 3 is a perspective drawing of a cap having a decorative element.

### DETAILED DESCRIPTION

The present invention generally relates to devices and methods for vehicle identification. Some embodiments include a plate bearing a visually communicative label and a radio frequency label. According to some embodiments the plate is mountable on a portion of a vehicle.

According to some embodiments, a plate can comprise a first face and a second face spaced apart from the first face and defining a thickness. In some embodiments the first and second faces comprise an approximately rectangular shape. In other embodiments, the first and second faces can comprise a variety of other shapes including, without limitation, circles, ellipses, triangles, pentagons, hexagons, heptagons, octagons, higher polygons or any combination thereof.

The plate can comprise any of a wide variety of polymer materials. Suitable polymers are compatible with one or more molding processes, and/or with in-mold labeling processes. Some suitable polymer materials include, without limitation, polyolefins such as polypropylene, polyethylene, high-density polyethylene, derivatives thereof, and/or any combination thereof. Other polymers include vinyl polymers, phenolic polymers, polycarbonates, polystyrene, polyesters, polyethylene teraphthalates, nylons, and the like, any derivatives thereof, any copolymers thereof, and/or any combination thereof.

Some embodiments can be made according to any of a wide variety of molding methods known in the art. One of ordinary skill in the art will be able to select an appropriate method and determine the appropriate steps and conditions therefor without undue experimentation. Some suitable molding methods include, without limitation, injection molding, thermoforming, blow molding, rotational molding, casting, extruding, stamping, or any combination thereof.

Some embodiments also include a visually communicative label. In some embodiments, the label can be an alphanumeric label. The visually communicative label can be formed according to any of a variety of processes known in the art. According to some embodiments the visual label can be formed by an in-mold labeling method. The specific details of in-mold labeling are known in the art, and would be readily determined by one of ordinary skill without undue experimentation. One of skill in the art will recognize that the in-mold label can comprise any of a wide variety of polymeric materials including, without limitation, one or more of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, polybutylene, polyethylene methyl acrylic acid, polyethylene ethyl acrylate, polyvinyl chloride, any derivative thereof, any blend thereof, or any copolymer thereof, and combination thereof.

Alternatively, some embodiments can comprise a visually communicative label comprising a pressure sensitive adhesive. For example, according to some embodiments the label can be formed by printing an alphanumeric sequence on a sheet, and coating one side of the sheet with a pressure sensitive adhesive. The sheet can then be adhered to a plate member thereby imparting a visually communicative alphanumeric sequence to the plate.

Some embodiments also include one or more radio frequency identification tags (hereinafter RFID). Any of a wide variety of known RFID tags can comprise a component of the present invention. Suitable RFID tags are adapted to withstand the thermal conditions of the selected polymer molding process. Furthermore, suitable RFID tags are capable of storing an alphanumeric identification sequence and/or transmitting a radio frequency signal representing an alphanumeric identification sequence. According to some embodiments the RFID tag is adapted to be programmed to transmit an alphanumeric identification sequence. Additionally, some embodiments include the capacity to reset and/or reprogram the alphanumeric identification sequence. More specifically, some embodiments are adapted to be reset and/or reprogrammed provided a security code is supplied.

The RFID tag can be incorporated in any number of ways. For example, according some embodiments the RFID tag can be bonded to the visual label, for instance, to the back of the visual label. In other embodiments, the RFID tag can be disposed in a polymer bulk. For example, where the plate comprises a molded polymer plate, the RFID tag can be embedded anywhere within the volume of the plate. In still other embodiments, the RFID tag can be bonded to an exterior surface of the plate. For instance, the RFID tag could be adhesively bonded with an adhesive substance to a front or back face of the plate. Alternatively, in some embodiments, the RFID tag can be fused to a surface of the plate by joining the two parts while both are in a molten or semi-molten state. In still other embodiments, the RFID tag can be removably adhered to an exterior surface of the plate, so that the tag can be replaced as needed.

Some embodiments also include one or more mounting structures for affixing the plate to a vehicle. Suitable mounting structures include any appropriate means for attaching a plate to a vehicle. Some appropriate means can include one or more through-holes for accepting a fastener such as a bolt or screw. Some embodiments include at least two through holes located near opposing edges of the plate. Other suitable mounting means can include, for instance, any of a wide variety of clips, grips, and/or locks for gripping a mounting portion of a vehicle.

In some embodiments, the mounting structure is adapted to receive a cover member. For instance, in some embodiments comprising through-holes for accepting fasteners, the through-hole may be adapted to additionally accept a cover member such as a cap. In some embodiments, the cover member comprises a cap having a generally concave inner surface and generally convex outer surface. In some embodiments, the cover member has an inner face and an outer face, and the cover member can include a clipping means for attaching the cap to the plate and/or mounting structure.

In one embodiment, the cover member comprises a cap. The cap has an inner face and an outer face. According to one embodiment, the faces each comprise an approximately circular shape. Alternatively, the faces can comprises ellipses, triangles, rectangles, pentagons, hexagons, heptagons, octagons, higher polygons or any combination thereof. The cap also includes a side-wall extending from a position at or near the perimeter of the inner face, thereby forming a cup-like structure. The side-wall includes a female clipping member disposed on an inner surface of the side-wall, and the female clipping member is mateable in a snap-fit relation with a male clipping member disposed on the plate. In some embodiments, the female clipping member comprises a beveled edge, which contacts a surface of the male clipping member and forces the female member to stretch over, and snap onto, the male member. One of skill in the art will recognize that a wide variety of clipping structures can be within the scope of the present invention. According to some embodiments the male clipping member can be a component of a face of the plate, and can be disposed around the perimeter of the mounting structure, e.g. through-hole. Accordingly, the cap can be clipped to the plate and cover a fastener.

The cover may provide a degree of protection to the fastener so as to impede corrosion. However, the cover may also function as a branding means, or even serve an aesthetic purpose. For example, an outwardly directed face of the cover member can include branding or decorative indicia such as a logo of a sports team, university, company, club, state or national seal, or a mark or seal of another organization. Such decorative elements can be formed on the cover member according to a wide variety of known methods including, without limitation, in-mold labeling, painting, dying, or attaching a separately-formed decorative element to the cover member such as by bonding, fusing, or fastening. In embodiments where the decorative element is formed according to an in-mold labeling process, the in-mold label can comprise any of a wide variety of materials including one or more polymers selected from the group consisting of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, polybutylene, polyethylene methyl acrylic acid, polyethylene ethyl acrylate, polyvinyl chloride, any derivative thereof, any blend thereof, or any copolymer thereof, and combination thereof.

Some embodiments are adapted for use in connection with one or more vehicles such as, motor vehicles including, but not limited to cars, trucks, and busses. Some embodiments may be adapted for use in connection with bicycles or other manually powered vehicles. Still other embodiments may be adapted for use in connection with aircraft, or with any of a wide variety of other vehicles that may benefit from such identification tags.

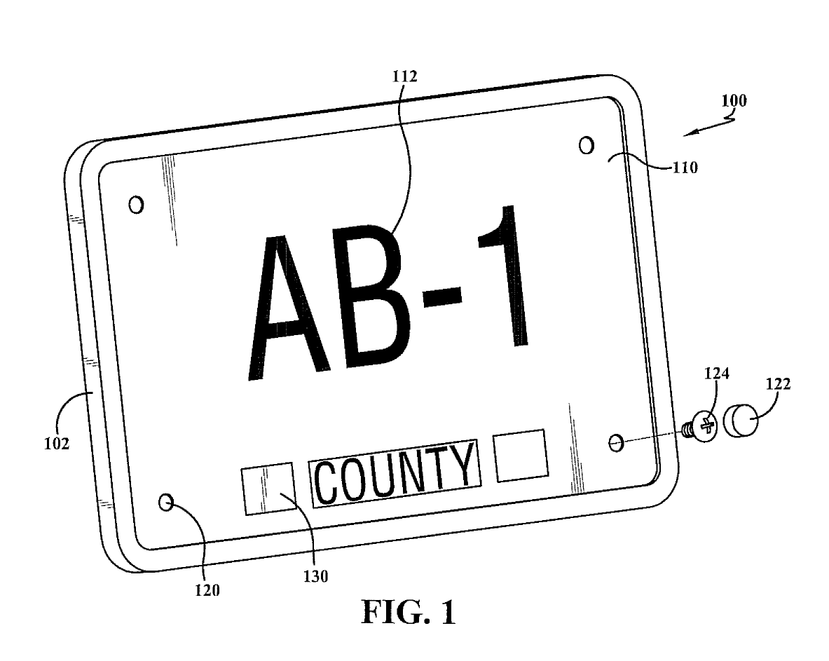

Referring now to the drawings wherein the showings are for purposes of illustrating embodiments of the invention only and not for purposes of limiting the same, FIG. 1 is an exploded perspective view drawing of an embodiment 100 comprising a license plate. The embodiment 100 comprises an approximately rectangular shape having a perimeter 102, a back face, and front face 110. The front face 110 includes a visually communicative alphanumeric label 112. The front face 110 also defines four mounting structures comprising through-holes 120, which are each adapted to receive a fastener 124 for mounting the embodiment 100 to a vehicle. Furthermore, the through-holes 120 are adapted to additionally receive a cover member comprising a cap 122. According to FIG. 1, an RFID chip is shown embedded within the bulk of the embodiment 100.

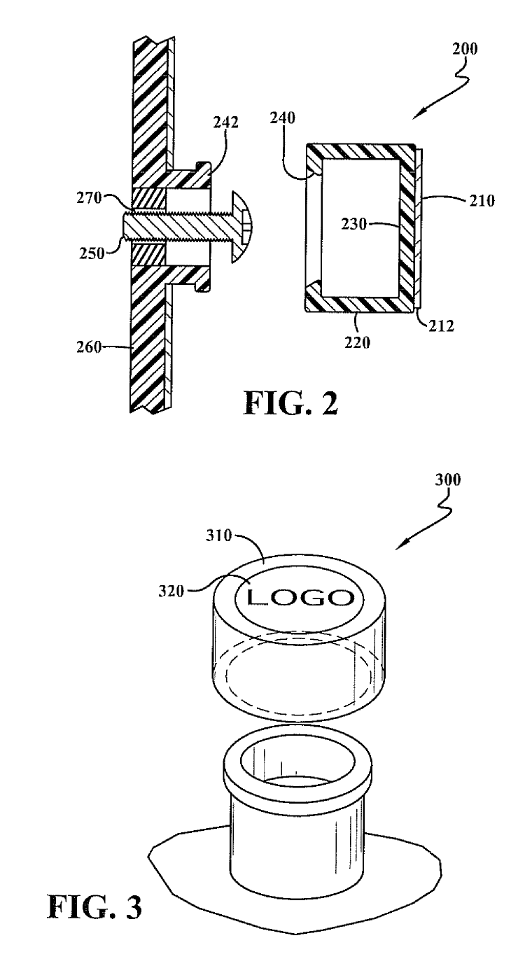

FIG. 2 is a cross sectional side view of an embodiment 200 having a through-hole mounting structure 270 receiving a fastener 250 and a cap-type cover member 210. The cap 210 includes a substantially cylindrical sidewall 220 partially enclosing an inner face 230. The inside surface of the sidewall 220 includes a female clipping member 240, which is mateable with a male clipping member 242 disposed on the plate 260. According to FIG. 2, the cap 210 can be attached to the plate 260 in a snap-fitted relation. The cap 210 also includes a decorative component 212 disposed on the outward facing surface of the cap 210. FIG. 3 is a perspective view drawing of an embodiment 300 having a cap with a logo 320 on the top face 310 of the cap.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

I/we claim:

1. A vehicle identification device, comprising:
a plate having a first face and a second face spaced apart from the first face and defining a thickness, the first and second faces defining an approximately rectangular shape, wherein the plate comprises one or more organic polymer materials, and wherein the plate further comprises a radio frequency identification label;
a visually communicative alphanumeric label disposed on the first face; and
at least one mounting structure adapted to mount the plate to a vehicle, the mounting structure being disposed on or in the plate.

2. The device of claim 1, wherein the one or more organic polymer materials is selected from the group consisting of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, and any combination thereof.

3. The device of claim 1, wherein the radio frequency identification tag is adhesively bonded to the visually communicative label.

4. The device of claim 1, wherein the radio frequency identification tag is embedded at any location within the plate.

5. The device of claim 1, wherein the radio frequency identification tag is bonded to a surface of the plate.

6. The device of claim 1, wherein the visually communicative alphanumeric label comprises an in-mold label or a pressure sensitive adhesive label.

7. The device of claim 6, wherein the in-mold or pressure sensitive adhesive label comprises one or more polymers selected from the group consisting of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, polybutylene, polyethylene methyl acrylic acid, polyethylene ethyl acrylate, polyvinyl chloride, and combination thereof.

8. The device of claim 1, wherein the at least one mounting structure comprises a through-hole for receiving a fastener.

9. The device of claim 8, wherein the through-hole is circumscribed by a male snap-fit member the male member being an integral part of the plate and the male member being adapted to mate with a female snap-fit member, the female snap-fit member being a part separate from the plate.

10. The device of claim 9, wherein the female snap-fit member comprises a cap adapted to enclose a fastener disposed in the through-hole.

11. A process for making a vehicle identification device, comprising the steps of:
providing at least one polymer material;
molding the at least one polymer material to form a rectangular plate structure;
embedding one or more in-mold label members in the polymer material; and
incorporating one or more radio frequency identification tags in the polymer material.

12. The process of claim 11, wherein the step of providing at least one polymer comprises providing one or more polymers selected from the group consisting of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, and any combination thereof.

13. The process of claim 11, wherein the step of molding comprises one or more of injection molding, thermoforming, rotational molding, blow molding, casting or extruding.

14. The process of claim 11, wherein the step of embedding includes embedding in-mold label members comprising one or more polymers selected from the group consisting of polyethylene, high-density polyethylene, polypropylene, acrylic polymers, butadiene polymers, styrene polymers, acetal polymers, nylon polymers, phenylene oxide polymers, polycarbonates, polyesters, polysulfone, urethane polymers, vinyl polymers, polybutylene, polyethylene methyl acrylic acid, polyethylene ethyl acrylate, polyvinyl chloride, and any combination thereof.

15. The process of claim 11, wherein the step of incorporating further comprises adhering the radio frequency identification tag to the in-mold label member.

16. The process of claim 11, wherein the step of incorporating comprises encasing the radio frequency identification tag in the polymer material and allowing the material to harden around the tag, wherein the tag can be disposed at any location within the plate structure.

17. The process of claim 11, wherein the step of incorporating further comprises bonding the radio frequency identification tag to a surface of the plate structure.

18. The process of claim 11, further comprising the step of forming a mounting component as an integral member of the plate structure.

19. The process of claim 18, wherein the mounting component comprises a male component adapted to mate with a female component in a snap-fitted relation.

20. A device for labeling a vehicle, comprising:
a means for conveying visually perceptible indicia;
a means for broadcasting a radio frequency signal indicia; and
a means for mounting the device onto a vehicle.
